(19) United States
(12) Patent Application Publication
(10) Pub. No.: US 2015/0048063 A1
(43) Pub. Date: Feb. 19, 2015

(54) LASER MACHINING APPARATUS

(71) Applicant: HON HAI PRECISION INDUSTRY CO., LTD., New Taipei (TW)

(72) Inventor: PO-CHOU CHEN, Tu-Cheng (TW)

(21) Appl. No.: 14/455,504

(22) Filed: Aug. 8, 2014

(30) Foreign Application Priority Data
Aug. 13, 2013 (TW) 102128955

(51) Int. Cl. B23K 26/06; B23K 26/36; B23K 26/08

(52) U.S. Cl. CPC B23K 26/0626; B23K 26/0652; B23K 26/0876; B23K 26/365
USPC 219/121.62

(57) ABSTRACT

A laser machining apparatus for manufacturing a light guide plate includes a laser source, a first prism, a detector, and a processor. The laser source is configured to emit a laser beam. The first prism includes a first optical surface, a first reflective surface and a second reflective surface. A sub wavelength grating is arranged and fixed on the second reflective surface. A portion of the laser beam is diffracted by the grating forming a diffraction beam. The detector captures and detects a real-time energy value of the diffraction beam. The processor receives the detected energy value, compares it with a preset energy value, calculates a to-be-increased value of the laser beam, and sends an instruction about the calculated value to the laser source.

### FIELD

The subject matter herein generally relates to a laser machining apparatus and, particularly, to a laser machining apparatus for manufacturing a light guide plate.

### BACKGROUND

A light guide plate is an important element in a backlight module. In order to improve uniformity of light output from the light guide plate, a dot-pattern-formation is formed on a surface of the light guide plate. The dot-pattern-formation can be formed via a laser machining apparatus.

### BRIEF DESCRIPTION OF THE DRAWINGS

Implementations of the present technology will now be described, by way of example only, with reference to the attached figures.

FIG. 1 is a diagrammatic view of an embodiment of a laser machining apparatus, including a laser unit.

FIG. 2 is a diagrammatic view of an embodiment of the laser unit of FIG. 1, wherein the laser unit includes a first prism and a second prism.

FIG. 3 is a diagrammatic view of another embodiment of the laser unit of FIG. 1, wherein the laser unit includes a first prism.

FIG. 4 is a diagrammatic view of an embodiment of the first prism of FIGS. 2-3.

FIG. 5 is a diagrammatic view of an embodiment of the second prism of FIG. 2.

FIG. 6 is a planar view of a light guide plate manufactured by the laser machining apparatus of FIG. 1.

FIG. 7 is a diagrammatic view of an alternative embodiment of the laser unit of FIG. 1 wherein the laser unit includes a first prism.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “comprising” when utilized, means “including, but not necessarily limited to”; it specifically indicates open-ended inclusion or membership in the so-described combination, group, series and the like. The references to “an” or “one” embodiment are not necessarily to the same embodiment, and such references mean “at least one.” The references “a plurality of” and “a number of” mean “at least two.”

The present disclosure is described in relation to a laser machining apparatus comprising a laser source, a first prism, a detector, and a processor. The laser source is configured to emit a laser beam. The first prism comprises a first optical surface, a first reflective surface, and a second reflective surface. A cross section of the first prism is an isosceles right triangle. The first optical surface is the hypotenuse of the isosceles right triangle. The first and second reflective surfaces are the right-angle sides of the isosceles right triangle respectively. A sub-wavelength grating is arranged on the second reflective surface. The laser beam enters the first prism through the first optical surface along a first incident direction perpendicular to the first optical surface and is totally internally reflected by the first reflective surface. A portion of the laser beam reflected by the first reflective surface is diffracted by the grating to form a diffraction beam and penetrates the grating. The remaining laser beam reflected by the first reflective surface is totally internally reflected by the second reflective surface and emits out of the first prism through the first optical surface along a first output direction reverse to the first light incident direction. The detector is configured to capture the diffraction beam, to detect a real-time energy value of the diffraction beam, and to send out the detected value. The processor is electrically connected to the laser source and the detector. The processor is configured to receive the detected value, to calculate a to-be-increased energy value of the laser beam according to the detected value, and to send an instruction about the calculated value to the laser source.

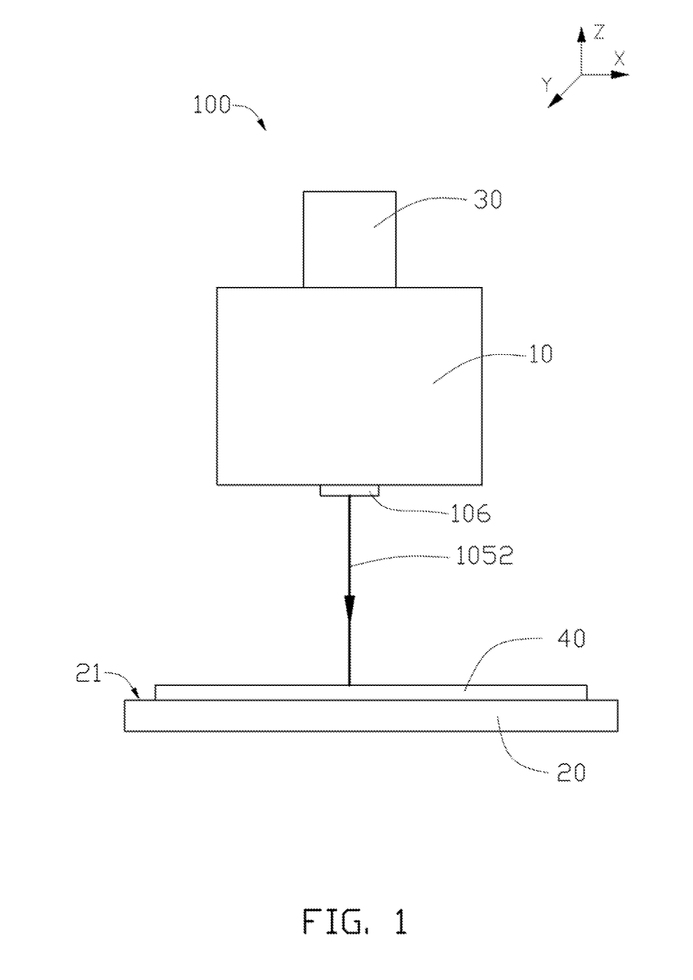

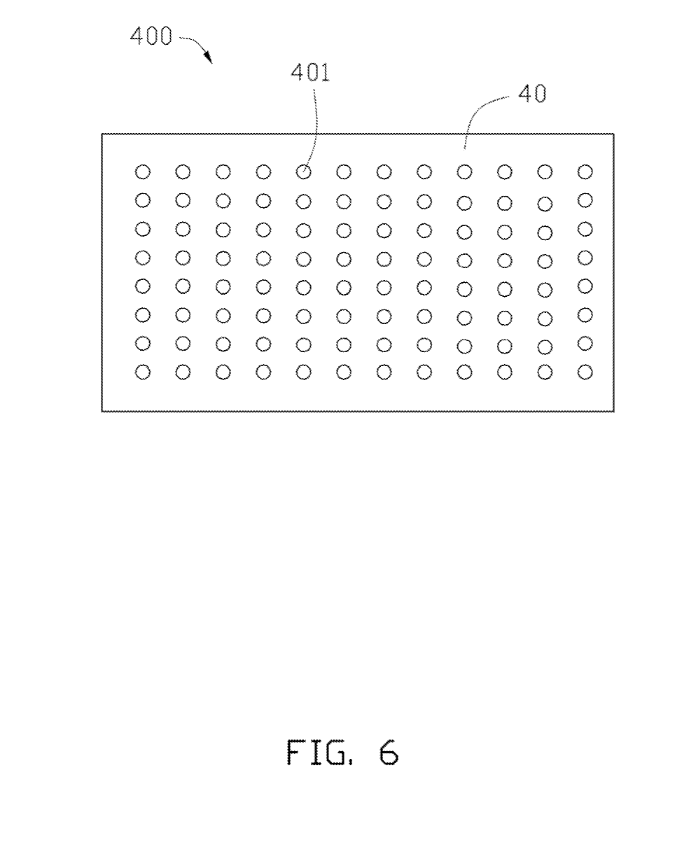

FIG. 1 illustrates an embodiment of a laser machining apparatus 100. The laser machining apparatus 100 includes a laser unit 10, a platform 20, and a driver unit 30. The laser machining apparatus 100 is configured for machining netted dots 401 on a substrate 40 (shown in FIG. 6).

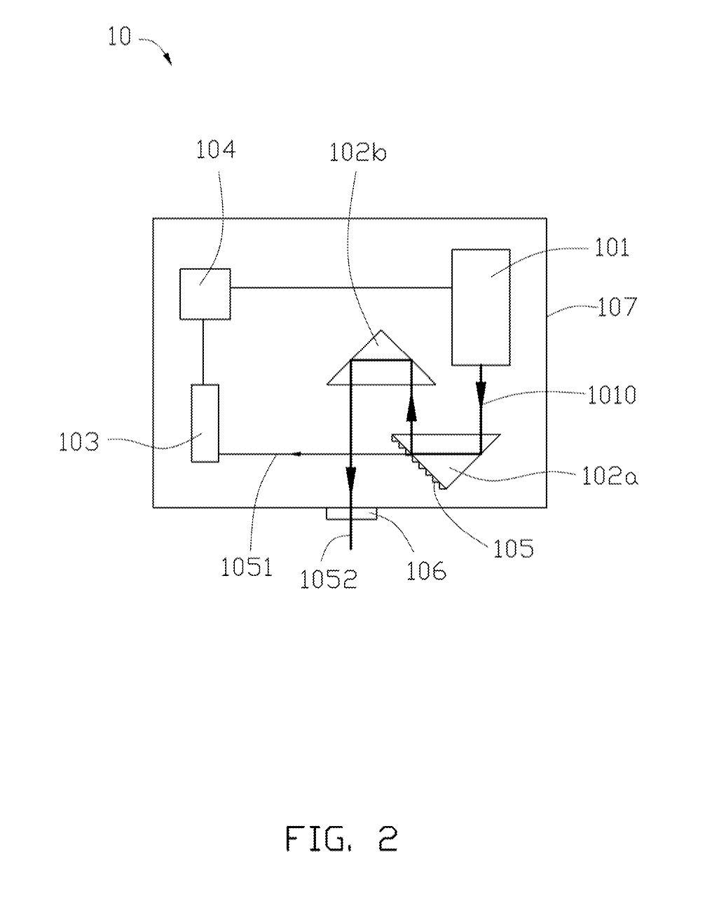

FIG. 2 illustrates that the laser unit 10 includes a housing 107, a laser source 101, a first prism 102a, a second prism 102b, a detector 103, and a processor 104. The laser source 101, the first prism 102a, the second prism 102b, the detector 103, and the processor 104 can be received in the housing 107. The housing 107 defines an opening 106. The opening 106 is configured to allow a processing beam 1052 to emit out of the laser unit 10.

The laser source 101 is configured to emit a laser beam 1010.

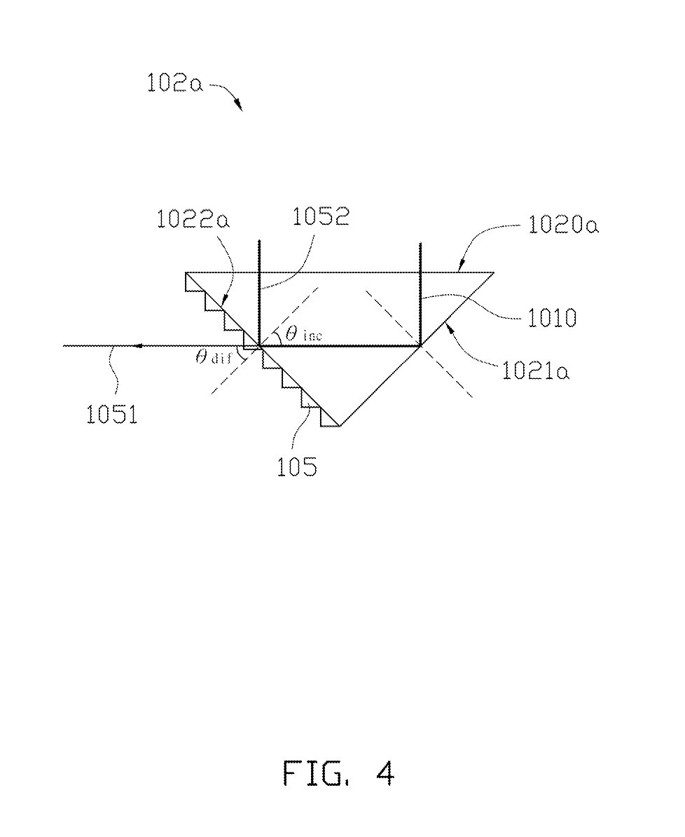

FIGS. 2 and 4 illustrate that the first prism 102a is configured to receive the laser beam 1010 emitted from the laser source 101. The first prism 102a includes a first optical surface 1020a, a first reflective surface 1021a, and a second reflective surface 1022a. In one embodiment, a cross section of the first prism 102a is substantially an isosceles right triangle. The first optical surface 1020a is the hypotenuse of the cross section. The first reflective surface 1021a is one of two right-angle sides of the cross section. The second reflective surface 1022a is the other one of two right-angle sides of the cross section. A sub-wavelength grating 105 is arranged on the second reflective surface 1022a. In one embodiment, the refractive index of the grating 105 can be adjustable by changing structural parameters of the grating 105, such as material, depth of grooves, or frequency of grooves. In one embodiment, the refractive index of the grating 105 is adjustable by changing the frequency of grooves. The frequency of grooves satisfies the following formula: Λ=mλ/(n₂ sin θ_{dif}−n₁sin θ_{inc}), wherein Λ represents the frequency of grooves of the grating 105, m represents a diffraction series of the grating 105, represents the wavelength of the laser beam 1010, n₁ represents the refractive index of the first prism 102a, n₂ represents the refractive index of a medium in which the diffraction beam 1051 transmits, θₘ represents a diffractive angle of the diffraction beam 1051, and θ_{inc} represents an incident angle of the laser beam 1010. In one embodiment, m=−1, θ_{inc}=θ_{dif}=45 degrees, the medium is air, that is, n₂=1, and n₁ is a constant, which is determined by material of the first prism 102a.

In one embodiment, a total internal reflection critical angle of the laser beam 1010 transmitting in the first prism 102a is less than 45 degrees. The laser beam 1010 emitting from the laser source 101 enters the first prism 102a through the first optical surface 1020a along a first incident direction perpendicular to the first optical surface 1020a, and is totally internally reflected by the first reflective surface 1021a towards the second reflective surface 1022a. A portion of the laser beam 1010 reflected by the first reflective surface 1021a is diffracted by the grating 105 and penetrates the grating 105 to form a diffraction beam 1051, and the remaining laser beam 1010 is reflected by the second reflective surface 1022a to form a processing beam 1052. The ratio between the energy value of the diffraction beam 1051 and of the processing beam 1052 is predetermined and can be adjustable. The processing beam 1052 emits out of the first prism 102a through the first optical surface 1020a along a first output direction reverse to the first incident direction.

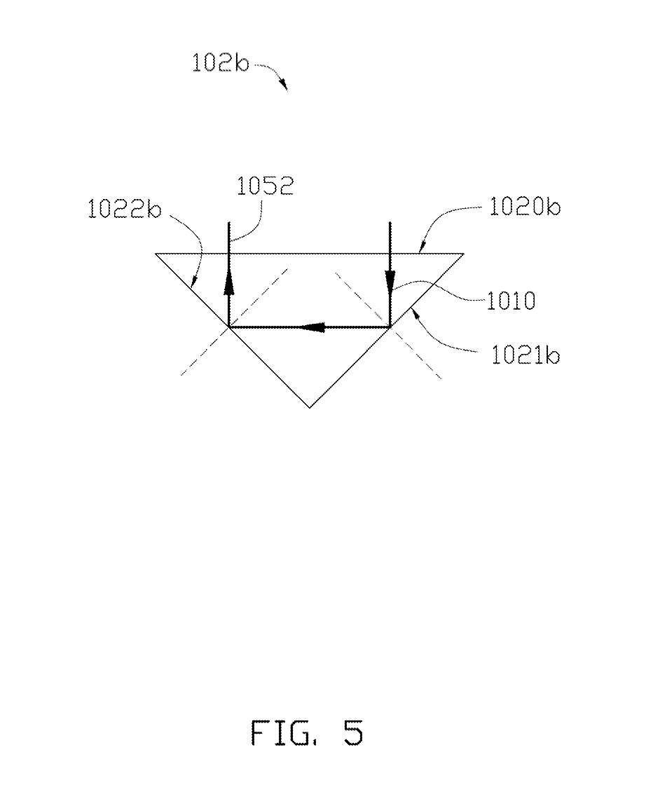

FIG. 5 illustrates that the second prism 102b includes a second optical surface 1020b, a third reflective surface 1021b, and a fourth reflective surface 1022b. In one embodiment, a cross section of the second prism 102b is an isosceles right triangle. The second optical surface 1020b is the hypotenuse of the cross section. The third reflective surface 1021b is one of two right-angle sides of the cross section. The fourth reflective surface 1022b is the other one of two right-angle sides of the cross section. The second optical surface 1020b faces the opening 106 and the first optical surface 1020a. In one embodiment, the second prism 102b is configured to change the transmission direction of the processing beam 1052. The processing beam 1052 emits out of the first prism 102a entering the second prism 102b through the second optical surface 1020b along a second incident direction perpendicular to the second optical surface 1020b, and is totally internally reflected by the third and fourth reflective surfaces 1021b and 1022b in sequence, and then emits out of the second prism 102b through the second optical surface 1020b along a second output direction reverse to the second incident direction. Finally, the processing beam 1052 emits out of the housing 107 through the opening 106.

The detector 103 is configured to capture the diffraction beam 1051, to detect real-time energy values of the diffraction beam 1051 at a specified time interval, and to send the detected values to the processor 104. The specified time interval is about in a range from 0.1 seconds to 1 second.

The processor 104 is electrically connected to the laser source 101 and the detector 103. The processor 104 is configured to receive the detected values. The detected values are compared with a preset value stored in the processor 104 to determine whether the energy of the laser beam 1010 decreases or not. When the energy of the laser beam 1010 is found to have reduced, a to-be increased energy value of the laser beam 1010 is calculated by the processor 104 according to the ratio between the energy values of the diffraction beam 1051 and of the processing beam 1052. The processor 104 sends an instruction of the calculated value to the laser source 101. The laser source 101 increases the energy value of the laser beam 1010 according to the instruction, thereby making the energy value of the laser beam 1010 remain constant.

In one embodiment, the ratio between the energy value of the diffraction beam 1051 and of the processing beaming 1052 is 1 to 19 (1:19). If the laser source 101 emits a laser beam 1010 with an energy value about 1 Watt (W). The energy that is diffracted by the grating 105 is about 0.05 W. The energy that is reflected by the second reflective surface 1021a is about 0.95 W. That is, the energy value of the diffraction beam 1051 is about 0.05 W and the energy value of the processing beam 1052 is about 0.95 W. The detector 103 receives the diffraction beam 1051, detects an original energy value of the diffraction beam 1051, and sends the original detected values to the processor 104. The processor 104 takes the original detected value 0.5 W as a preset value. The preset value is stored in the processor 104. When the energy value of the laser beam 1010 attenuates to 0.9 W, the energy value of the diffraction beam 1051 detected by the detector 103 is about 0.045 W. The detector 103 sends the attenuated detected value 0.045 W to the processor 104. The processor 104 receives the attenuated detected value. The attenuated detected value is compared with the preset value. The processor 104 determines that the energy value of the laser beam 1010 has reduced, calculates a to-be-increased energy value about 0.1 W of the laser beam 1010, and sends an instruction of the calculated value 0.1 W to the laser source 101. The laser source 101 increases the energy value of the laser beam 1010 according to the instruction, thereby making the energy value of the laser beam 1052 remain about 1 W.

The driver unit 30 is configured to drive the laser unit 10 to move along an X axis direction, a Y axis direction, and a Z axis direction. Therefore, the dot-pattern-formation of the netted dots 401 is determined by moving the driver unit 30 along the X axis direction and the Y axis direction. The thickness of each of the netted dots 401 is determined by moving the driver unit 30 along the Z axis.

The platform 20 comprises a supporting surface 21. The supporting surface 21 is configured to support and fix the substrate 40. The laser unit 10 faces the supporting surface 21. The processing beam 1052 emitting from laser unit 10 is perpendicular to the supporting surface 21.

When in use, the substrate 40 is arranged and fixed on the platform 20. The driver unit 30 drives the laser unit 10 to move along the X, Y, and Z axis, the processing beam 1052 machines a surface of the substrate 40 to form netted dots 401, thereby forming a light guide plate 400.

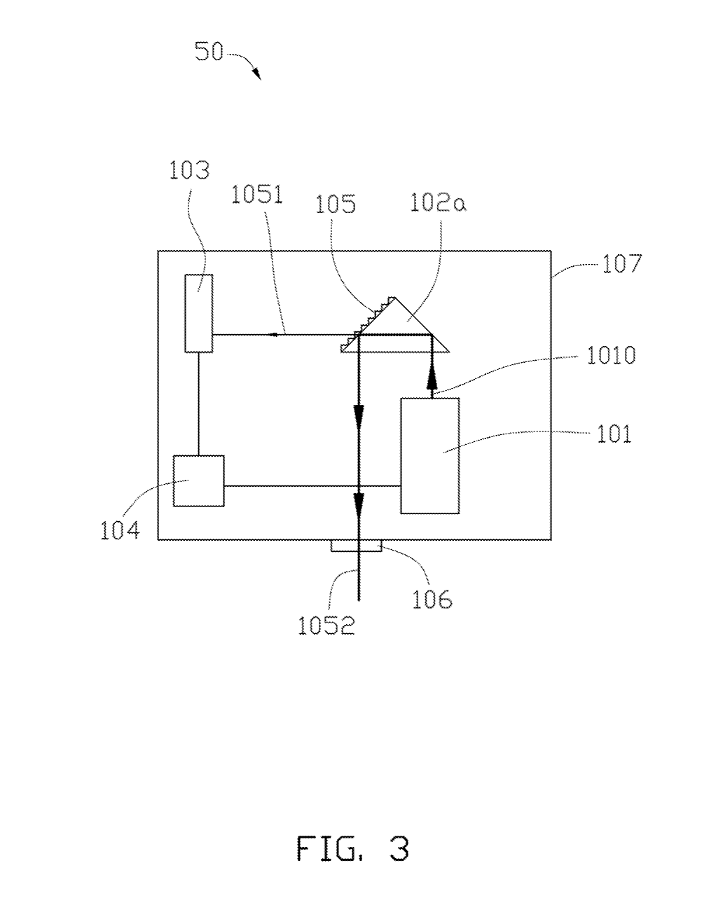

In other embodiments, as FIG. 3 illustrated, a laser unit 50 different from the laser unit 10 is provided. In this case, the second prism 102b can be omitted. The first optical surface 1020a faces the opening 106 and the laser source 101. The processing beam 1052 emits from the housing 101 through the opening 106 after emitting from the first prism 102a.

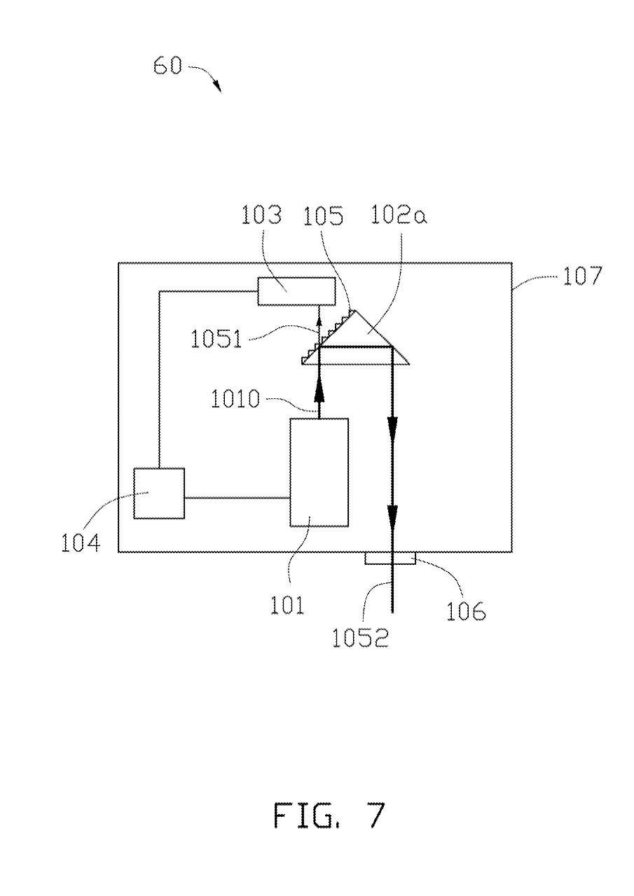

FIG. 7 illustrates that the embodiment of FIG. 3 can be modified so that the sub-wavelength grating 105 is arranged on the first reflective surface of the prism 102a. In other words, a laser unit 60 different from the laser unit 10 and laser unit 50 is provided. In this case, the prism 102a is arranged so that the laser beam 1010 is first reflected internally by the reflective surface carrying the sub-wavelength grating 10a. Therefore the diffraction beam 1051 is colinear with the laser beam 1010 emitted from the laser source 101.

The embodiments shown and described above are only examples. Many details are often found in the art such as the other features of a laser machining apparatus. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A laser machining apparatus comprising:
a laser source configured to emit a laser beam;
a first prism comprising a first optical surface, a first reflective surface, and a second reflective surface, a cross section of the first prism being an isosceles right triangle, the first optical surface being the hypotenuse of the cross section, the first and second reflective surfaces being the right-angle sides of the cross section respectively, a sub-wavelength grating arranged on the second reflective surface, the first prism being arranged for the laser beam to enter the first prism through the first optical surface along a first incident direction perpendicular to the first optical surface and to be reflected by the first reflective surface, a portion of the laser beam reflected by the first reflective surface to be diffracted by the grating to form a diffraction beam, the remaining laser beam to be totally internally reflected by the second reflective surface and emitted out of the first prism through the first optical surface along an first output direction reverse to the first incident direction;
a detector configured to capture the diffraction beam, to detect a real-time energy value of the diffraction beam, and to send out the detected value; and
a processor electrically connected to the laser source and the detector, and configured to receive the detected value, to compare the detected value with a preset value, to calculate a to-be-increased energy value of the laser beam according to the detected value, and send an instruction about the calculated value to the laser source.

2. The laser machining apparatus of claim 1 further comprising a housing configured to receive the laser source, the first prism, the detector, and the processor, wherein the housing defines an opening, the processing beam emits out of the housing through the opening.

3. The laser machining apparatus of claim 2 further comprising a driver unit and a platform, wherein the driver unit is configured to drive the laser unit to machine a substrate to form a dot-pattern-formation on a surface of the substrate, and the platform is configured to support and fix the substrate.

4. The laser machining apparatus of claim 3, wherein the driver unit is configured to drive the laser unit move along horizontal and vertical directions.

5. The laser machining apparatus of claim 3, wherein the platform comprises a supporting surface facing the laser unit.

6. The laser machining apparatus of claim 2, wherein the laser unit further comprises a second prism received in the housing, the second prism comprises a second optical surface, a third reflective surface, and a fourth reflective surface, a cross section of the second prism is a isosceles right triangle, the second optical surface is the hypotenuse of the cross section, the third and fourth reflective surfaces are the right-angle sides of the cross section respectively, the second prism being arranged for the processing beam emitted out of the first prism to enter the second prism through the second optical surface along a second incident direction perpendicular to the second optical surface, and to be reflected by the third and fourth reflective surfaces in sequence, and then emitted out of the second prism through the second optical surface along a second output direction reverse to the second incident direction, and finally emitted out of the housing through the opening.

7. A laser machining apparatus comprising:
a laser source configured to emit a laser beam;
a first prism comprising a first optical surface, a first reflective surface, and a second reflective surface, a cross section of the first prism being an isosceles right triangle, the first optical surface being the hypotenuse of the cross section, the first and second reflective surfaces being the right-angle sides of the cross section respectively, a sub-wavelength grating arranged on one of the first and second reflective surfaces, the first prism being arranged for the laser beam to enter the first prism through the first optical surface along a first incident direction perpendicular to the first optical surface and to be internally reflected by the first and second reflective surfaces and to be emitted out of the first prism through the first optical surface along a first output direction reverse to the first incident direction, and a portion of the laser beam entering the first prism to be diffracted by the grating to form a diffraction beam emitted out of the first prism through said one of the first and second reflective surfaces;
a detector configured to capture the diffraction beam, to detect a real-time energy value of the diffraction beam, and to send out the detected value, and
a processor electrically connected to the laser source and the detector, and configured to receive the detected value, to compare the detected value with a preset value, to calculate a to-be-increased energy value of the laser beam according to the detected value, and send an instruction about the calculated value to the laser source.
